(19) United States
(12) Patent Application Publication
(10) Pub. No.: US 2004/0025412 A1
(43) Pub. Date: Feb. 12, 2004

(54) Insect trap

(76) Inventors: Miriam Simchoni, D.N. Merom Hagalil (IL); Meir Shinitzky, Kfar Shmaryahu (IL)

Correspondence Address: FAY, SHARPE, FAGAN, MINNICH & McKEE, LLP, Suite 700, 1100 Superior Ave., Cleveland, OH, 44114-2518, US

(21) Appl. No.: 10/358,025

(22) Filed: Feb. 4, 2003

Related U.S. Application Data
(63) Continuation-in-part of application No. 09/555,386, filed on Aug. 21, 2000, now Pat. No. 6,516,559.

(30) Foreign Application Priority Data
Nov. 26, 1997 (IL) 122306

(51) Int. Cl. A01M 1/20

(52) U.S. Cl. 43/107

(57) ABSTRACT

A device and method for trapping flying insects including a housing having an opening for the entry of insects; a physical attractant for the insects; a trapping arrangement arranged in association with the physical attractant for trapping insects attracted thereto; and an emission arrangement for emitting a chemical attractant for the insects employing a cartridge which contains predetermined amounts of preselected chemical reactants and which engages the trapping device so that the cartridge is operative to enable the emission arrangement to produce a gaseous suspension of the chemical attractant in the vicinity of the trapping device.

### RELATED APPLICATIONS

The present application is a continuation-in-part of co-pending application Ser. No. 09/555,386 filed Nov. 26, 1998, entitled “Insect Trap,” the entire contents being incorporated herein by reference.

### FIELD OF THE INVENTION

The present invention relates generally to insect trapping and, more specifically, to trapping flying insects which feed on blood of warm-blooded animals.

### BACKGROUND OF THE INVENTION

Insects use their senses to search for food. A combination of chemical and physical factors, whether by virtue of either their sheer existence or their presence in a definite magnitude range, are intercepted by the insect sensory organs to direct the insect towards the potential food source. Such factors that cause the insect to approach them will henceforth be referred to as attractants. A prominent attractant cited repeatedly in the literature is carbon dioxide (e.g., Edman, “Orientation of some Florida mosquitoes towards small vertebrates and carbon dioxide in the field,” Journal of Medical Entomology, 15:292-296, 1979). An organic molecule, 1-octen-3-ol, is also potentially attractive to mosquitoes and other insects, alone or in combination with other factors (e.g. Hall et al., “1-octen-3-ol: a potent olfactory stimulant and attractant for tsetse isolated from cattle odors,” Insect Science and its Applications, 5:535-539, 1984).

Female mosquitoes need to consume a certain amount of mammalian blood in order to complete the breeding cycle and are therefore equipped with necessary facilities for accomplishing this task. In this context, female mosquitoes are provided with a potency to detect mammals, including humans.

Mosquito bites are a source of great inconvenience and are also a disease transmission pathway. There is accordingly a constant search for effective ways to eliminate mosquitoes. Up to now there has not been found an efficient practical method of effectively eliminating this pest. One method of eliminating mosquitoes proposed in the past is by luring them into traps.

Several factors have been shown previously to serve as attractants of insects in various kinds of traps; for example, carbon dioxide, octenol, and animal odors (e.g. Becker et al., Medical and Veterinary Entomology, 9:377-380, 1995). Poultry protein has also been proposed as a fly attractant together with microorganisms capable of digesting the protein (U.S. Pat. No. 4,849,216 to Andersen et al.). Another type of insect attractant proposed for use in traps comprising various other components is yeast together with a carbohydrate source which it is capable of fermenting (see for example, Bouillard, J., et al., in French Patent Publication FR 2705200). Dieguez, J. M., et al., in U.S. Pat. No. 5,382,422, describe a method for providing a flow of carbon dioxide gas containing a vapor of a liquid insect attractant selected from acetone and octanol. A trap for hematophagous insects utilizing a methanol fuel cell to provide carbon dioxide, water vapor, and heat as attractive agents, was proposed by Miller, M. H., in U.S. Pat. No. 5,669,176. Moreover, carbon dioxide chemically generated for use as an insect attractant, was disclosed in U.S. Pat. No. 4,506,473 to J. Waters, Jr., et al. U.S. Pat. No. 6,425,202 to Lin discloses “Microbe-mediated Method and Apparatus for Attracting Mosquitoes” employing chemical attractants, but does not physical attractants.

The entire contents of the above-mentioned patents, patent applications and literature articles are incorporated by reference herein.

### SUMMARY OF THE INVENTION

The present invention seeks to provide a device for trapping flying insects incorporating most features known to attract mosquitoes and blood-sucking flying insects, including both physical and chemical attractants. In particular, the present invention seeks to simulate qualities of warm-blooded animals that are the natural prey of mosquitoes and other blood-sucking flying insects, such as body temperature, breathing, and color.

The present invention further seeks to provide a device for trapping flying insects that features efficient and effective use of materials to generate chemical attractants for the insects and their dispersal in the vicinity of the device, and that is easy to use and charge with the materials.

There is thus provided, in accordance with a preferred embodiment of the invention, a device for trapping flying insects which includes:

a housing having an opening for the entry of insects;

a physical attractant for the insects, arranged within the housing so as to be visible by an insect within sight of the opening and including a dark panel and a heating source to heat the dark panel to a temperature within a preselected temperature range of 35 to 45° C., as well as a grille enclosing the dark panel to present a patterned view thereof to an insect within sight of the opening of the device;

a trapping arrangement, such as an adhesive applied to the dark panel, for trapping insects attracted to the physical attractant; and

an emission arrangement for emitting a chemical attractant in the vicinity of the trapping arrangement, thereby, in conjunction with the physical attractant, to attract insects into the trapping arrangement, so as to be entrapped thereby.

Additionally in accordance with a preferred embodiment of the invention, the emission arrangement is operative to give rise to predetermined environmental conditions which facilitate chemical reactions among preselected chemical reactants; including at least one of: fermenting yeast, yeast extract, sugar, peptone, acetone, and lactic acid; the conditions including a combination of: temperature, aeration, hydration, and percentage composition of the chemical reactants; thereby causing emission of the chemical attractant, including carbon dioxide, in a gaseous suspension, which further may have temporal variation in the density thereof, in the vicinity of the device.

Further in accordance with a preferred embodiment of the invention, the emission arrangement and the preselected chemical reactants are operative, in producing the gaseous suspension of the chemical attractant, to facilitate both aerobic and anaerobic processes, though preferably fostering the former, involving the metabolic activity of microorganisms such as yeast with substrates such as sugar in an aqueous medium, wherein the aerobic processes include aerobic respiration and the anaerobic processes include fermentation.

In accordance with a further preferred embodiment of the invention, the emission arrangement further includes:

an air pump for producing a flow of air;

bubble producing apparatus arranged to receive the flow of air from the air pump and further arranged to deliver the flow of air to the aqueous medium so as to produce air bubbles therein, via a number of apertures, preferably of a diameter of approximately 0.5 mm, in an aperture plate included in the bubble producing apparatus and interposed in the air flow adjacent to the aqueous medium, at a rate predetermined to provide a degree of aeration required to foster the aerobic processes in producing the gaseous suspension of the chemical attractant; and

an air conduit connecting the air pump and the bubble producing apparatus configured to direct the air flow produced by the air pump into the bubble producing apparatus.

Additionally in accordance with a further preferred embodiment of the invention, the emission arrangement and the air pump are further operative to drive the gaseous suspension of the chemical attractant into the region in the vicinity of the device.

In accordance with an alternative embodiment of the invention, the emission arrangement further includes a heater operative to maintain the chemical reactants at an optimum temperature to facilitate the respiration and fermentation processes.

Further in accordance with an additional preferred embodiment of the invention, the emission arrangement includes a replaceable inner module which contains predetermined amounts of the preselected chemical reactants, the chemical reactants, when activated by the addition of a predetermined quantity of water to the replaceable inner module, reacting to produce the chemical attractant, and which engages the emission arrangement, releasing the attractant thereinto, so that the predetermined amounts of preselected chemical reactants in the replaceable inner module are operative to enable the emission arrangement to supply the device with a quantity of the chemical attractant sufficient for it to function for a predetermined period of time. Further, the replaceable inner module is arranged for selectable removal from the device when the preselected chemical reactants are exhausted.

There is thus also provided, in accordance with a further preferred embodiment of the invention, for use with a device for trapping flying insects, an emission arrangement for emitting a chemical attractant for the insects employing a cartridge which contains predetermined amounts of preselected chemical reactants sufficient to enable the emission arrangement to supply the trapping device with a quantity of the chemical attractant sufficient for it to function for a predetermined period of time, the chemical reactants, when activated by the addition of a predetermined quantity of water thereto, reacting to produce the chemical attractant when, and which engages the emission arrangement, releasing the attractant thereinto, thereby enabling the emission arrangement to produce a gaseous suspension of the chemical attractant in the vicinity of the trapping device. Further, the cartridge is configured as a replaceable inner module arranged for selectable removal from the trapping device when the preselected chemical reactants are exhausted.

Additionally in accordance with a preferred embodiment of the invention, the emission arrangement is operative to give rise to predetermined environmental conditions which facilitate chemical reactions among preselected chemical reactants; including at least one of: fermenting yeast, yeast extract, sugar, peptone, acetone, and lactic acid; the conditions including a combination of: temperature, aeration, hydration, and percentage composition of the chemical reactants; thereby causing emission of the chemical attractant, including carbon dioxide, in a gaseous suspension, which further may have temporal variation in the density thereof, in the vicinity of the device.

Further in accordance with a preferred embodiment of the invention, the emission arrangement and the preselected chemical reactants are operative, in producing the gaseous suspension of the chemical attractant, to facilitate both aerobic and anaerobic processes, though preferably fostering the former, involving the metabolic activity of microorganisms such as yeast with substrates such as sugar in an aqueous medium, wherein the aerobic processes include aerobic respiration and the anaerobic processes include fermentation.

In accordance with a further preferred embodiment of the invention, the emission arrangement further includes:

an air pump for producing a flow of air;

bubble producing apparatus arranged to receive the flow of air from the air pump and further arranged to deliver the flow of air to the aqueous medium so as to produce air bubbles therein, via a number of apertures, preferably of a diameter of approximately 0.5 mm, in an aperture plate included in the bubble producing apparatus and interposed in the air flow adjacent to the aqueous medium, at a rate predetermined to provide a degree of aeration required to foster the aerobic processes in producing the gaseous suspension of the chemical attractant; and

an air conduit connecting the air pump and the bubble producing apparatus configured to direct the air flow produced by the air pump into the bubble producing apparatus.

Additionally in accordance with a further preferred embodiment of the invention, the emission arrangement and the air pump are further operative to drive the gaseous suspension of the chemical attractant into the region in the vicinity of the trapping device.

In accordance with an alternative embodiment of the invention, the emission arrangement further includes a heater operative to maintain the chemical reactants at an optimum temperature to facilitate the respiration and fermentation processes.

There is thus additionally provided, in accordance with a still further preferred embodiment of the invention, for use with a device for trapping flying insects including an emission arrangement for emitting a chemical attractant for the insects,

a cartridge which contains predetermined amounts of preselected chemical reactants sufficient to enable the emission arrangement to supply the trapping device with a quantity of the chemical attractant sufficient for it to function for a predetermined period of time, the chemical reactants, when activated by the addition of a predetermined quantity of water thereto, reacting to produce the chemical attractant, and which engages the emission arrangement, releasing the attractant thereinto, thereby enabling the emission arrangement to produce a gaseous suspension of the chemical attractant in the vicinity of the trapping device. Further, the cartridge is configured as a replaceable inner module arranged for selectable removal from the trapping device when the preselected chemical reactants are exhausted. The preselected chemical reactants include including at least one of: fermenting yeast, yeast extract, sugar, peptone, acetone, and lactic acid; and the chemical attractant includes carbon dioxide.

Further in accordance with a preferred embodiment of the invention, the emission arrangement and the preselected chemical reactants are operative, in producing the gaseous suspension of the chemical attractant, to facilitate both aerobic and anaerobic processes, though preferably fostering the former, involving the metabolic activity of microorganisms such as yeast with substrates such as sugar in an aqueous medium, wherein the aerobic processes include aerobic respiration and the anaerobic processes include fermentation.

In accordance with a further preferred embodiment of the invention, the cartridge further includes bubble producing apparatus and the emission arrangement further includes:

an air pump for producing a flow of air and

an air conduit connecting the air pump and the bubble producing apparatus configured to direct the air flow produced by the air pump through the bubble producing apparatus;

and wherein the bubble producing apparatus is arranged to receive the flow of air from the air pump and further arranged to deliver the flow of air to the predetermined quantity of water so as to produce air bubbles therein, via a number of apertures, preferably of a diameter of approximately 0.5 mm, in an aperture plate included in the bubble producing apparatus and interposed in the air flow adjacent to the predetermined quantity of water, at a rate predetermined to provide a degree of aeration required to foster the aerobic processes in producing the gaseous suspension of the chemical attractant;

and wherein the emission arrangement further includes:

an air conduit connecting the air pump and the bubble producing apparatus configured to direct air pumped by the air pump through the bubble producing apparatus.

In accordance with yet a further preferred embodiment of the invention, for use with a device for trapping flying insects which includes: a housing having an opening for the entry of insects; a physical attractant for the insects; a trapping arrangement arranged in association with the physical attractant for trapping insects attracted thereto; and an emission arrangement for emitting a chemical attractant for the insects employing a cartridge which contains predetermined amounts of preselected chemical reactants and which engages the trapping device so that the cartridge is operative to enable the emission arrangement to produce a gaseous suspension of the chemical attractant in the vicinity of the trapping device,

there is provided a method for trapping insects, including the steps of:

furnishing, in a line-of-sight relationship to the opening of the trapping device, a physical attractant that is dark in color;

heating the dark physical attractant to a temperature within a preselected temperature range;

enclosing the dark physical attractant with a grille so as to present a patterned view thereof to an insect within sight of the opening of the trapping device; and

producing a gaseous suspension of a chemical attractant to attract insects in the vicinity of the trapping device.

Further in accordance with a preferred embodiment of the invention, the step of producing includes the substeps of:

supplying chemical reactants operative to produce the chemical attractant;

providing predetermined environmental conditions operative to facilitate reactions, including both aerobic and anaerobic processes, among the chemical reactants to produce the chemical attractant; and

activating the reactions to produce the chemical attractant, which includes adding a predetermined quantity of water to the cartridge.

Additionally in accordance with a preferred embodiment of the invention, the step of supplying chemical reactants is supplying yeast and a nutrient substrate, and, in the step of providing, aerobic processes are respiration and anaerobic processes are fermentation.

Further in accordance with a preferred embodiment of the invention, the step of supplying chemical reactants is engaging in the trapping device a cartridge, configured as a replaceable inner module and containing predetermined amounts of preselected chemical reactants sufficient to enable the emission arrangement to supply the trapping device with a quantity of the chemical attractant sufficient for it to function for a predetermined period of time.

Additionally in accordance with a preferred embodiment of the invention, the step of providing predetermined environmental conditions

is providing predetermined environmental conditions operative to foster aerobic processes among the chemical reactants in producing the gaseous suspension of the chemical attractant, which includes the step of aerating the chemical reactants by driving air bubbles therethrough,

and may further include the step of heating the chemical reactants to an optimum temperature to facilitate the respiration and fermentation processes.

Further in accordance with a preferred embodiment of the invention, the step of producing a gaseous suspension of a chemical attractant further includes the substep of driving the gaseous suspension of the chemical attractant into the region in the vicinity of the trapping device.

### BRIEF DESCRIPTION OF THE DRAWINGS

The present invention will be more fully understood and appreciated from the following detailed description, taken in conjunction with the drawings, in which:

FIG. 1 is a schematic side view of a trapping device, constructed and operative in accordance with an embodiment of the present invention;

FIG. 2 is an exploded view of a trapping device, constructed and operative in accordance with a preferred embodiment of the present invention; and

FIG. 3 is a representation of the reactant cup of the embodiment of the present invention shown in FIG. 2.

### DETAILED DESCRIPTION OF THE INVENTION

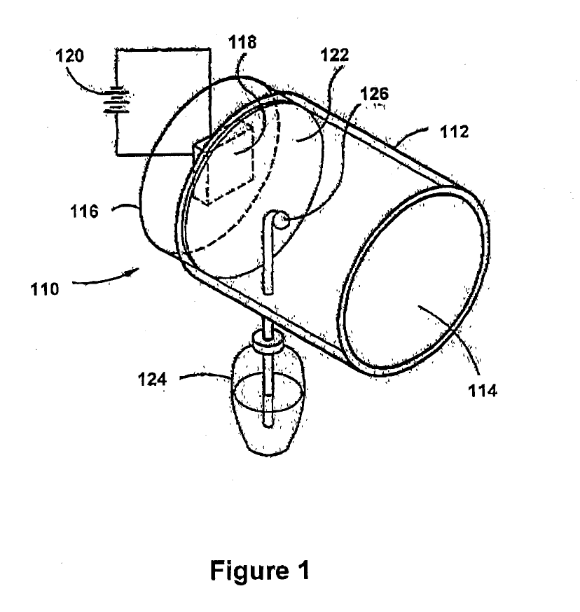

Referring now to FIG. 1, there is shown a schematic side view of a device for trapping flying insects, referred to generally as 100, constructed and operative in accordance with an embodiment of the present invention. Trapping device 100 includes a tube 112 with an opening 114 having a heating unit 116 at the other end thereof the tube in heat-conducting association with heating element 118 connected to power source 120. Attached to the rear wall of tube 112, overlaying heating unit 116, is a black panel 122, which is covered by an adhesive, which serves to trap mosquitoes or other flying insects attracted thereto. Trapping device 100 further includes a fermentation vessel 124 having an exhaust outlet 126 in the vicinity of panel 122.

In practice, vessel 124 is supplied with yeast and mixed with a nutritional substance, such as sucrose, in an aqueous substrate, giving rise to fermentation, which emits carbon dioxide (CO₂), which, as cited hereinabove, is a known attractant to mosquitoes, via exhaust outlet 126. The yeast may be incorporated in a sustained release formulation, known per se, in order to ensure a uninterrupted supply of CO₂ for emission.

In co-pending U.S. patent application Ser. No. 09/555,386, of which the present application is a continuation-in-part, included herein by reference, results of various experimental tests are presented, showing the effectiveness of employing a dark-colored panel over a light-colored one and that of heating the panel to approximately 37° C., in attracting mosquitoes.

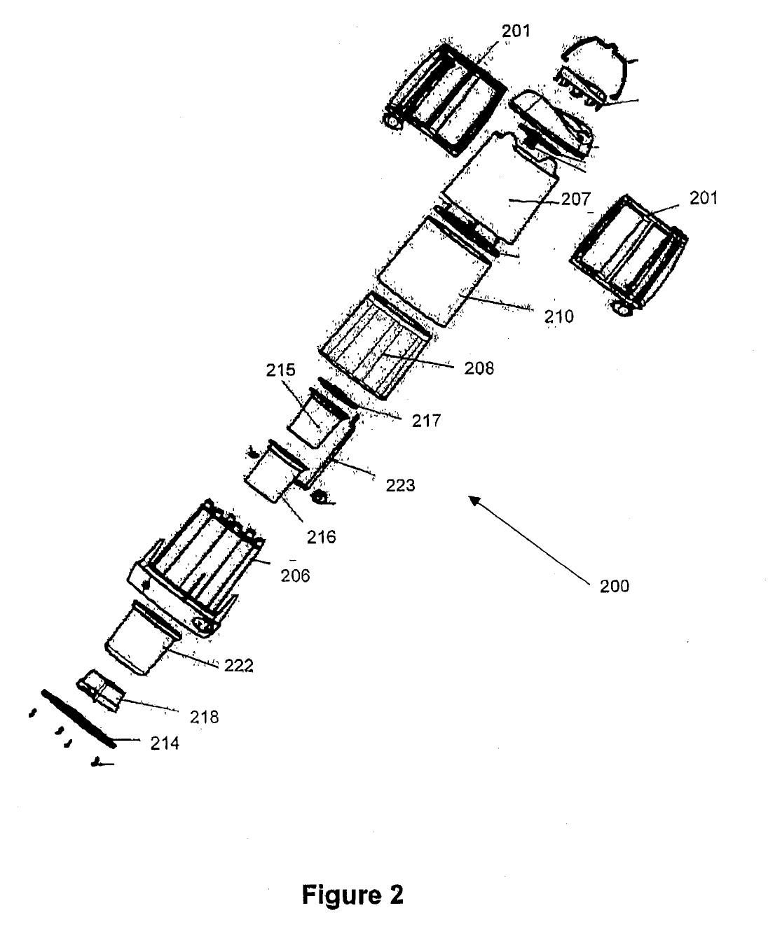

Referring now to FIG. 2, there is shown an exploded view of a device for trapping flying insects, referred to generally as 200, constructed and operative in accordance with a preferred embodiment of the present invention. Insects attracted to trapping device 200 are actually trapped by trapping cylinder 207, which is covered an adhesive substance suitable for trapping any insects coming into contact therewith. In accordance with a preferred embodiment of the present invention, trapping cylinder 207 is dark in color, preferably black. Trapping cylinder 207 further is in thermal contact internally with heat sink 210, which, in turn, is in thermal contact with cylindrical heating unit 208, which, together serve to heat trapping cylinder 207 to a temperature in the range 35° C. to 45° C., preferably close to 41° C., and to maintain trapping cylinder 207 at the desired temperature. U.S. patent application Ser. No. 09/555,386, of which the present application is a continuation-in-part, included herein by reference, presents the advantages of a dark-colored surface, heated to 37° C., in attracting mosquitoes. The present embodiment has been found to be particularly effective in trapping mosquitoes when trapping cylinder 207 is heated close to 41° C. Trapping cylinder 207 is mounted on base 206 and is enclosed by grille 201 and its associated cover 202 and 205 which together serve as a housing for trapping device 200. Grille 201 further serves to define an opening for the entry of flying insects into trapping device 200. In addition, grille 201 presents the dark colored surface of trapping cylinder 207 as a patterned, and, in the present case, vertically striped surface which has been shown (See, for example, Mosquito Ecology: Field Sampling Methods, M. W. Service, Applied Science Publishers Ltd., London, 1976, pp. 358-362.) to make such surfaces more effective in attracting mosquitoes.

In the present preferred embodiment, base 206 further serves as an enclosure for air pump 218, which is mounted on pump base 214 which engages base 206. Air pump 218, via tube 223, forces air into reactant cup enclosure 222 and thereby through reactant cup 215, 216, and 217. The inner cup 215 of the reactant cup contains reactants which, upon reacting, produce a gaseous suspension of one or more chemical attractants to attract mosquitoes or other flying insects into trapping device 200. Outer cup 216 of the reactant cup may be in thermal contact with a cup heater (not included in the present embodiment, and hence, not shown) to heat the cup to a temperature to facilitate reactions to produce the chemical attractants. In the present embodiment, heat from cylindrical heating unit 208 and heat sink 210 serves also to heat trapping device 200 in the vicinity of the reactant cup; this heat, together with the heat produced by the reactions occurring in the cup maintain a temperature of approximately 27° C. therein, which facilitates reactions to produce the chemical attractants, doing so at a rate which does not deplete the reactants more rapidly than would be desired. The gaseous suspension of chemical attractants comes through heating unit 208 and trapping cylinder 207 and exits trapping device 200 via grille 201 to form a cloud of chemical attractants in the vicinity of the opening to trapping device 200 to attract mosquitoes or other flying insects therein. It should be noted that the present embodiment has been found to be effective at attracting other blood-sucking flying insects, such as sand flies, as well as other flying insects, such as houseflies and fruit flies.

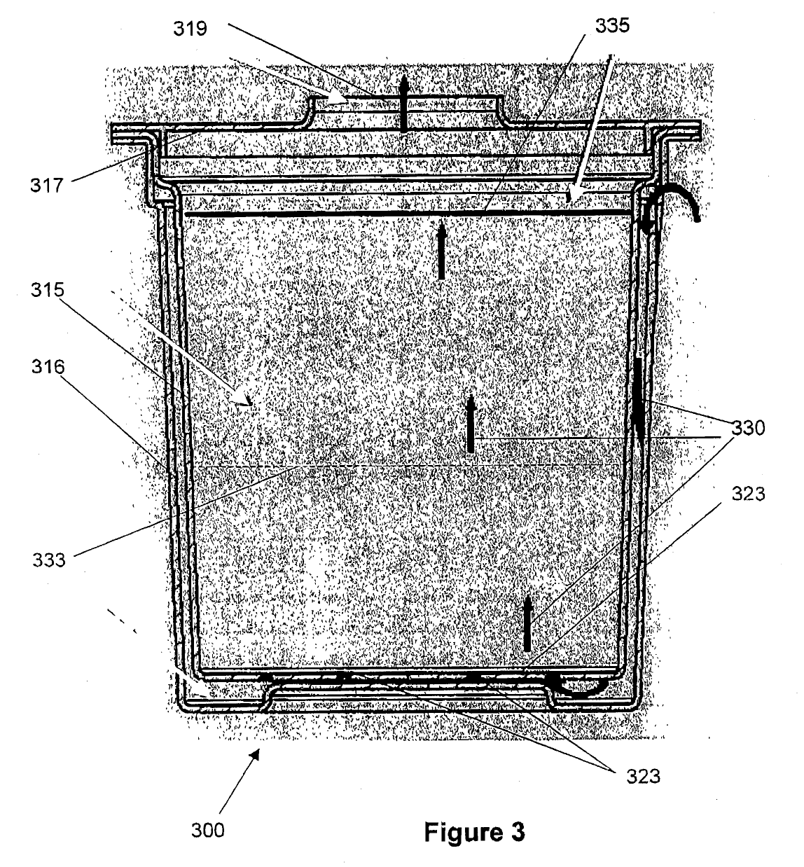

Referring briefly to FIG. 3, there is shown a representation of the reactant cup, referred to generally as 300, of the present embodiment of the present invention. Reactant cup 300 includes inner cup 315, outer cup 316, and cup cover 317. Air pumped by air pump 218 via tube 223 (FIG. 2) enters the space between inner cup 315 and outer cup 316 via openings 321 near the rim of out cup 316. The flat bottom 323 of inner cup 315 is fabricated with a number of apertures 325 of predetermined diameter, preferably 0.5 mm, allowing thereby, the air to enter inner cup 315 and exit via a large aperture 319 in cup cover 317. Air flow through reactant cup is indicated by arrows 330. In practice, inner cup 315 will be charged with a predetermined quantity of preselected reactants up to the level referred to as 333. To activate reactant cup 300, water is added up to the level referred to as 335, thereby activating the reactants to start the processes to produce the gaseous suspension of one or more chemical attractants to attract mosquitoes or other flying insects, until the reactants are depleted.

In a particularly preferred embodiment of the present invention, reactant cup 300 is fabricated as a replaceable inner module or cartridge, that comes charged with predetermined quantities of preselected reactants sufficient to allow trapping device 200 to operate for a predetermined period of time, and that is arranged to be selectably removed from the trapping device, as when said preselected chemical reactants are exhausted. In practice, a measured amount of water is added to the reactants in reactant cup 300 immediately before installation in trapping device 200 to activate the reactants to start the reactions that produce the attractants.

U.S. patent application Ser. No. 09/555,386, of which the present application is a continuation-in-part, included herein by reference, discloses a trapping device employing CO₂, which, as cited hereinabove, is a known attractant to mosquitoes, as the primary chemical attractant, which is produced by the action of microorganisms, on a suitable nutrient substrate in an aqueous medium. In particular, fermentation of sugar in aqueous medium by yeast is employed. The cited application further presents results of various experimental tests showing the advantages of additives, for example, peptones, which can also serve as a nutrient to the microorganisms, to the reactant mix of yeast and sugar, thereby producing, as a chemical attractant, CO₂ with additional amounts of acetone and lactic acid. This represents a preferred embodiment of the invention disclosed therein. It should be noted however, that, as is known to those familiar with the art, even “simple” fermentation of sugar in aqueous medium by yeast, without other additives, produces dozens of other compounds, in addition to CO₂, including a number of which, individually or in combination which each other, are known to attract mosquitoes and other flying insects.

It should further be noted that, as is known to those familiar with the art, there is an alternative process whereby yeast acting on sugar will produce CO₂, rather than by fermentation, which is an anaerobic process. If there is sufficient aeration, the yeast can produce CO₂ by respiration, an aerobic process. Further, as is known to those familiar with the art, yeast produces by respiration approximately three times the quantity of CO₂ that it produces by fermentation, from the same quantity of sugar. Additionally, fermentation also produces alcohol, which can reach a concentration toxic to the yeast cells, eventually killing them off.

Thus it can be seen that providing yeast with an environment that fosters respiration over fermentation affords a twofold advantage with respect to objectives of the present invention; namely, more efficient production of CO₂ together with reduced depletion of the supply of yeast needed to produce it.

Returning now to FIG. 3, the aforementioned air flow 330 through the reactants in an aqueous substrate will, as a result of the multiplicity of apertures 325 in bottom 323 of inner cup 315, take the form of bubbles. In accordance with a preferred embodiment of the present invention, cup 300 will be charged with yeast in a suitable form, as disclosed in U.S. patent application Ser. No. 09/555,386, and sugar, to which the designated quantity (up to level 335) of water is added. The bubbling through the aqueous mixture of yeast and sugar will provide aeration to foster the aerobic process of respiration in the yeast. It has been found by the inventors that this can be optimized by apertures 355 approximately 0.5 mm diameter. In addition, the bubbles draw water vapor along with the air and the CO₂ produced by the yeast. This makes the resulting gaseous suspension more attractive to mosquitoes and other blood-sucking flying insects than would be the case for dry CO₂, as is known to those familiar with the art. Further, as described hereinabove, the cup 300 and the mixture therein are maintained, by heat from cylindrical heating unit 208 and heat sink 210 (FIG. 2) and from the reactions occurring in the cup, at a temperature of approximately 27° C., which facilitates reactions at a rate which does not deplete the reactants more rapidly than would be desired. The result is more efficient production of CO₂ and a longer time period that trapping device 200 (FIG. 2) can operate on a single charging of cup 300 with reactants. In the case of the particularly preferred embodiment wherein cup 300 is configured as a replaceable cartridge, the cartridge replacement cycle time is longer.

It should further be noted that the release of gaseous suspension of CO₂ by the action of microorganisms, such as yeast, via respiration and fermentation, especially as produced by the present embodiment of the present invention, will tend to be in bursts or pulses, producing thereby temporal variation in the density of the CO₂, as opposed to the uniform emission that comes from a gas cylinder filled with CO₂. As will be understood by those familiar with the art, this “pulsed” emission is more attractive to mosquitoes and other blood-sucking flying insects than uniform emission, since it simulates the emission of CO₂ by warm-blooded animals, the natural prey of mosquitoes and other blood-sucking flying insects, as they breathe. It should further be noted that though the present invention has initially been found to be effective at attracting mosquitoes and other blood-sucking flying insects, such as sand flies, it has also been found to be effective in attracting other flying insects, such as houseflies and fruit flies as well.

It will further be appreciated by persons skilled in the art that the scope of the present invention is not limited by what has been specifically shown and described hereinabove, merely by way of example. Rather, the scope of the present invention is defined solely by the claims, which follow.

1. A device for trapping flying insects, including:
a housing having an opening for the entry of insects;
a physical attractant for the insects, arranged within said housing so as to be visible by an insect within sight of said opening;
a trapping arrangement arranged in association with said physical attractant for trapping insects attracted to said physical attractant; and
an emission arrangement for emitting a chemical attractant in the vicinity of said trapping arrangement, thereby, in conjunction with said physical attractant, to attract insects into said trapping arrangement, so as to be entrapped thereby.

2. A device according to claim 1, wherein said emission arrangement is operative to give rise to predetermined environmental conditions which facilitate chemical reactions among preselected chemical reactants: thereby causing emission of the chemical attractant.

3. A device according to claim 2, wherein said predetermined environmental conditions include a combination of: temperature, aeration, hydration, and percentage composition of said chemical reactants.

4. A device according to claim 1, wherein said emission arrangement is further operative to produce a gaseous suspension of the chemical attractant in the vicinity of said device.

5. A device according to claim 4, wherein said emission arrangement is further operative to produce a gaseous suspension of the chemical attractant having temporal variation in the density of the chemical attractant.

6. A device according to claim 1, wherein said physical attractant includes a dark panel and a heating source operative to heat said dark panel to a temperature within a preselected temperature range.

7. A device according to claim 6, wherein said physical attractant further includes a grille enclosing said dark panel which is operative to present a patterned view thereof to an insect within sight of said opening of said device.

8. A device according to claim 6, wherein said heating source is operative to heat said dark panel to a temperature within the range of 35 to 45° C.

9. A device according to claim 1, wherein said trapping arrangement includes an adhesive.

10. A device according to claim 9, wherein said adhesive is applied to said dark panel.

11. A device according to claim 2, wherein said preselected chemical reactants includes at least one member of the group which consists of: fermenting yeast, yeast extract, sugar, peptone, acetone, and lactic acid; and wherein the chemical attractant includes carbon dioxide.

12. A device according to claim 2, wherein said emission arrangement and said preselected chemical reactants are operative, in producing said gaseous suspension of the chemical attractant, to facilitate both aerobic and anaerobic processes involving the metabolic activity of microorganisms with substrates in an aqueous medium, wherein said aerobic processes include aerobic respiration and said anaerobic processes include fermentation.

13. A device according to claim 12, wherein said microorganisms are yeast and said substrates include sugar.

14. A device according to claim 12, wherein said emission arrangement and said preselected chemical reactants are further operative to preferably foster said aerobic processes in producing said gaseous suspension of the chemical attractant.

15. A device according to claim 14, wherein said emission arrangement further includes:
an air pump for producing a flow of air;
bubble producing apparatus arranged to receive the flow of air from said air pump and further arranged to deliver the flow of air to said aqueous medium so as to produce air bubbles therein at a rate predetermined to provide a degree of aeration required to foster said aerobic processes in producing said gaseous suspension of the chemical attractant; and
an air conduit connecting said air pump and said bubble producing apparatus configured to direct the air flow produced by said air pump into said bubble producing apparatus.

16. A device according to claim 15, wherein said bubble producing apparatus includes an aperture plate interposed in the air flow adjacent to said aqueous medium and having a multiplicity of apertures of predetermined diameters optimal for producing the air bubbles in said aqueous medium.

17. A device according to claim 16, wherein the diameter of each said aperture in said aperture plate is approximately 0.5 mm.

18. A device according to claim 15, wherein said emission arrangement and said air pump are further operative to drive said gaseous suspension of the chemical attractant into the region in the vicinity of said device.

19. A device according to claim 12, wherein said emission arrangement further includes a heater operative to maintain said preselected chemical reactants at an optimum temperature to facilitate said respiration and fermentation processes.

20. A device according to claim 1, wherein said emission arrangement includes a replaceable inner module which contains predetermined amounts of said preselected chemical reactants, said chemical reactants, when activated, reacting to produce the chemical attractant, and which engages said emission arrangement, releasing the attractant thereinto, so that said predetermined amounts of preselected chemical reactants in said replaceable inner module are operative to enable said emission arrangement to supply said device with a quantity of the chemical attractant sufficient for it to function for a predetermined period of time.

21. A device according to claim 20, wherein said emission arrangement and said replaceable inner module are arranged to allow the reacting of said chemical reactants to be selectably activated by the addition of a predetermined quantity of water to said replaceable inner module prior to engaging said emission arrangement.

22. A device according to claim 20, wherein said replaceable inner module is arranged for selectable removal from said device when said preselected chemical reactants are exhausted.

23. For use with a device for trapping flying insects, which includes: a housing having an opening for the entry of insects; a physical attractant for the insects; and a trapping arrangement arranged in association with said physical attractant for trapping insects attracted to said physical attractant,
an emission arrangement for emitting a chemical attractant for the insects employing a cartridge which contains predetermined amounts of preselected chemical reactants, said chemical reactants, when activated, reacting to produce the chemical attractant, and which engages said emission arrangement, releasing the attractant thereinto, thereby enabling said emission arrangement to produce a gaseous suspension of the chemical attractant in the vicinity of the trapping device.

24. An emission arrangement according to claim 23, wherein said predetermined amounts of preselected chemical reactants in said cartridge are sufficient to enable said emission arrangement to supply the trapping device with a quantity of the chemical attractant sufficient for it to function for a predetermined period of time.

25. An emission arrangement according to claim 23, wherein said emission arrangement and said cartridge are arranged to allow the reacting of said chemical reactants to be selectably activated by the addition of a predetermined quantity of water to said cartridge prior to engaging said emission arrangement.

26. An emission arrangement according to claim 23, wherein said cartridge is configured as a replaceable inner module arranged for selectable removal from the trapping device when said preselected chemical reactants are exhausted.

27. An emission arrangement according to claim 23, which is operative to give rise to predetermined environmental conditions which facilitate chemical reactions among said preselected chemical reactants, thereby causing emission of the chemical attractant.

28. An emission arrangement according to claim 23, which is further operative to produce a gaseous suspension of the chemical attractant having temporal variation in the density of the chemical attractant.

29. An emission arrangement according to claim 27, wherein said predetermined environmental conditions include a combination of: temperature, aeration, hydration, and percentage composition of said chemical reactants.

30. An emission arrangement according to claim 23, wherein said preselected chemical reactants includes at least one member of the group which consists of: fermenting yeast, yeast extract, peptone, acetone, and lactic acid; and wherein the chemical attractant includes carbon dioxide.

31. An emission arrangement according to claim 23, wherein said emission arrangement and said preselected chemical reactants are operative, in producing said gaseous suspension of the chemical attractant, to facilitate both aerobic and anaerobic processes involving the metabolic activity of microorganisms with substrates in an aqueous medium, wherein said aerobic processes include aerobic respiration and said anaerobic processes include fermentation.

32. An emission arrangement according to claim 31, wherein said microorganisms are yeast and said substrates include sugar.

33. An emission arrangement according to claim 31, further operative, together with said preselected chemical reactants, to preferably foster said aerobic processes in producing said gaseous suspension of the chemical attractant.

34. An emission arrangement according to claim 33, further including:
an air pump for producing a flow of air;
bubble producing apparatus arranged to receive the flow of air from said air pump and further arranged to deliver the flow of air to said aqueous medium so as to produce air bubbles therein at a rate predetermined to provide a degree of aeration required to foster said aerobic processes in producing said gaseous suspension of the chemical attractant; and
an air conduit connecting said air pump and said bubble producing apparatus configured to direct the air flow produced by said air pump into said bubble producing apparatus.

35. An emission arrangement according to claim 34, wherein said bubble producing apparatus includes an aperture plate interposed in the air flow adjacent to said aqueous medium and having a multiplicity of apertures of predetermined diameters optimal for producing the air bubbles in said aqueous medium.

36. A emission arrangement according to claim 35, wherein the diameter of each said aperture in said aperture plate is approximately 0.5 mm.

37. An emission arrangement according to claim 34, further operative, together with said air pump, to drive said gaseous suspension of the chemical attractant into the region in the vicinity of the trapping device.

38. An emission arrangement according to claim 31, further including a heater operative to maintain said preselected chemical reactants at an optimum temperature to facilitate said respiration and fermentation processes.

39. For use with a device for trapping flying insects, which includes: a housing having an opening for the entry of insects; a physical attractant for the insects; a trapping arrangement arranged in association with said physical attractant for trapping insects attracted to said physical attractant; and an emission arrangement for emitting a chemical attractant for the insects,
a cartridge which contains predetermined amounts of preselected chemical reactants, said chemical reactants, when activated, reacting to produce the chemical attractant, and which engages the emission arrangement, releasing the attractant thereinto, thereby enabling the emission arrangement to produce a gaseous suspension of the chemical attractant in the vicinity of the trapping device.

40. A cartridge according to claim 39, wherein said predetermined amounts of preselected chemical reactants therein are sufficient to enable the emission arrangement to supply the trapping device with a quantity of the chemical attractant sufficient for it to function for a predetermined period of time.

41. A cartridge according to claim 39, arranged, together with the emission arrangement, to allow the reacting of said chemical reactants to be selectably activated by the addition of a predetermined quantity of water thereto prior to engaging the emission arrangement.

42. A cartridge according to claim 39, configured as a replaceable inner module arranged for selectable removal from the trapping device when said preselected chemical reactants are exhausted.

43. A cartridge according to claim 39, wherein said preselected chemical reactants includes at least one member of the group which consists of: fermenting yeast, yeast extract, peptone, acetone, and lactic acid; and wherein the chemical attractant includes carbon dioxide.

44. A cartridge according to claim 39, wherein the emission arrangement, together with said cartridge and said preselected chemical reactants are operative, in producing said gaseous suspension of the chemical attractant, to facilitate both aerobic and anaerobic processes involving the metabolic activity of microorganisms with substrates in an aqueous medium, wherein said aerobic processes include aerobic respiration and said anaerobic processes include fermentation.

45. A cartridge according to claim 44, wherein said microorganisms are yeast and said substrates include sugar.

46. A cartridge according to claim 44, wherein said preselected chemical reactants, with the action of the emission arrangement, are operative to preferably foster said aerobic processes in producing said gaseous suspension of the chemical attractant.

47. A cartridge according to claim 46, further including bubble producing apparatus, wherein the emission arrangement further includes:
an air pump for producing a flow of air and an air conduit connecting the air pump and said bubble producing apparatus configured to direct the air flow produced by the air pump through said bubble producing apparatus;
and wherein said bubble producing apparatus is arranged to receive the flow of air from the air pump and further arranged to deliver the flow of air to said predetermined quantity of water so as to produce air bubbles therein at a rate predetermined to provide a degree of aeration required to foster said aerobic processes in producing said gaseous suspension of the chemical attractant;
and wherein the emission arrangement further includes:
an air conduit connecting the air pump and said bubble producing apparatus configured to direct air pumped by the air pump through said bubble producing apparatus.

48. A cartridge according to claim 47, wherein said bubble producing apparatus includes an aperture plate interposed in the air flow adjacent to said predetermined quantity of water and having a multiplicity of apertures of predetermined diameters optimal for producing the air bubbles in said predetermined quantity of water.

49. A cartridge according to claim 48, wherein the diameter of each said aperture in said aperture plate is approximately 0.5 mm.

50. For use with a device for trapping flying insects which includes: a housing having an opening for the entry of insects; a physical attractant for the insects; a trapping arrangement arranged in association with the physical attractant for trapping insects attracted thereto; and an emission arrangement for emitting a chemical attractant for the insects employing a cartridge which contains predetermined amounts of preselected chemical reactants and which engages the trapping device so that the cartridge is operative to enable the emission arrangement to produce a gaseous suspension of the chemical attractant in the vicinity of the trapping device, a method for trapping insects, including the steps of:
furnishing, in a line-of-sight relationship to the opening of the trapping device, a physical attractant that is dark in color;
heating the dark physical attractant to a temperature within a preselected temperature range;
enclosing the dark physical attractant with a grille so as to present a patterned view thereof to an insect within sight of the opening of the trapping device; and
producing a gaseous suspension of a chemical attractant to attract insects in the vicinity of the trapping device.

51. A method according to claim 50, wherein said step of producing includes the substeps of:
supplying chemical reactants operative to produce the chemical attractant;
providing predetermined environmental conditions operative to facilitate reactions, including both aerobic and anaerobic processes, among the chemical reactants to produce the chemical attractant; and
activating the reactions to produce the chemical attractant.

52. A method according to claim 51, wherein said step of supplying chemical reactants is supplying yeast and a nutrient substrate, and, in said step of providing, aerobic processes are respiration and anaerobic processes are fermentation.

53. A method according to claim 51, wherein said step of supplying chemical reactants is engaging in the trapping device a cartridge, configured as a replaceable inner module and containing predetermined amounts of preselected chemical reactants sufficient to enable the emission arrangement to supply the trapping device with a quantity of the chemical attractant sufficient for it to function for a predetermined period of time.

54. A method according to claim 51, wherein said step of activating includes adding a predetermined quantity of water to the cartridge.

55. A method according to claim 51, wherein said step of providing predetermined environmental conditions is providing predetermined environmental conditions operative to foster aerobic processes among the chemical reactants in producing the gaseous suspension of the chemical attractant.

56. A method according to claim 51, wherein said step of providing predetermined environmental conditions further includes the step of heating the chemical reactants to an optimum temperature to facilitate the respiration and fermentation processes.

57. A method according to claim 55, wherein said step of providing predetermined environmental conditions operative to foster includes the step of aerating the chemical reactants.

58. A method according to claim 57, wherein said step of aerating the chemical reactants includes the step of driving air bubbles therethrough.

59. A method according to claim 50, wherein said step of producing further includes the substep of driving the gaseous suspension of the chemical attractant into the region in the vicinity of the trapping device.
